(19) United States
(12) Patent Application Publication
(10) Pub. No.: US 2013/0314093 A1
(43) Pub. Date: Nov. 28, 2013

(54) METHOD AND SYSTEM EMPLOYING A SOLUTION CONTACT FOR MEASUREMENT

(71) Applicant: First Solar, Inc., Perrysburg, OH (US)

(72) Inventors: Long Cheng, Perrysburg, OH (US); Markus Gloeckler, Perrysburg, OH (US)

(73) Assignee: First Solar, Inc., Perrysburg, OH (US)

(21) Appl. No.: 13/900,177

(22) Filed: May 22, 2013

Related U.S. Application Data
(60) Provisional application No. 61/650,219, filed on May 22, 2012.

(51) Int. Cl. G01N 17/02

(52) U.S. Cl. CPC G01N 17/02
USPC 324/425

(57) ABSTRACT

An inline metrology method and system using an electrolytic cell for measuring electrical characteristics of a semiconductor device, such as a photovoltaic device, during manufacture.

### CROSS-REFERENCE TO RELATED APPLICATION

This application claims priority to U.S. Provisional Application No. 61/650,219, filed May 22, 2012, the disclosure of which is hereby incorporated by reference in its entirety.

### TECHNICAL FIELD

Embodiments disclosed herein relate to a method and system using a solution contact for analyzing a photovoltaic semiconductor device on a substrate.

### BACKGROUND

Photovoltaic (PV) devices (i.e., PV cells, PV modules, etc.) are semiconductor devices that exploit the properties of semiconductor materials to absorb light and generate electricity. Two or more PV cells can form a PV module.

FIG. 2 shows, in cross section, one example of a thin film PV device 10a which includes multiple layers formed on a substrate 1001 (or superstrate). For example, a PV device 10a can include a barrier layer 1002, a transparent conductive oxide (TCO) layer 1003, a buffer layer 1004, a semiconductor layer 1005, and a back contact layer 1006 formed in a stack on a substrate 1001. Each layer 1001, 1002, 1003, 1004, 1005, 1006 may in turn include more than one layer or film. For example, the semiconductor layer 1005 can include a semiconductor window layer (e.g., cadmium sulfide (CdS)) and semiconductor absorber layer (e.g., cadmium telluride (CdTe) or copper indium gallium selenide (CIGS)) adjacent the semiconductor window layer. After being deposited, the semiconductor layer 1005 may be annealed. Additionally, each layer can cover all or a portion of the device and/or all or a portion of the layer or substrate underlying the layer. For example, a “layer” can mean any amount of any material that contacts all or a portion of a surface. A back cover 1007 is also provided, which together with the substrate 1001 or superstrate, serves to protect the internal structure of the PV device 10. PV devices may also include at least a positive terminal and a negative terminal to permit travel of the generated electricity from the PV device to other PV devices or an electric grid.

Manufacture of a PV device typically requires multiple sequential processing steps, which provide multiple material layers (e.g., 1002, 1003, 1004, 1005, 1006) on the substrate 1001. The formation of each one of these layers requires at least one processing step. In addition, some layers may have to be treated chemically, thermally, or otherwise before and/or after formation. This treatment requires additional processing steps. As part of the formation of the layers on a substrate or superstrate, the layers are also patterned into individual PV cells.

At some of these processing steps, electrical characteristics and/or properties of the PV device may need to be measured to ensure the PV device's conformity to particular specifications or parameters. To do so, the PV device needs to have at least two electrical contacts with which a testing device may interface. Generally, two of the layers formed during the construction of a thin film PV device are electrical contact layers. These are the TCO layer 1003 and the back contact layer 1006 of FIG. 2. In a superstrate configuration, although the TCO layer 1003 is one of the first few layers formed during the construction of the PV device, the back contact layer 1006 is among the last layers formed. Waiting to test the electrical characteristics until the back contact layer 1006 is formed may foreclose corrective action if the PV device were not to meet particular specifications. In such cases, the PV device may have to be discarded. This is also true in substrate configuration, where the back contact layer 1006 is one of the first layers formed and the TCO layer 1003 is one of the last layers formed.

Instead of waiting until after both contact layers 1003 and 1006 are formed to take those measurements, one or more electrical contacts may be temporarily attached to the device whenever measurements are needed. Doing so, however, may disrupt the manufacturing line, and physical contact may cause irreversible changes to the device.

For example, the layers of the PV device are often formed by vapor transport deposition. Vapor transport deposition is a method by which a thin film of a material is deposited on a substrate by condensation of a vaporized form of the material. This usually occurs in a sterile, high temperature vacuum environment. Attaching electrical contacts to the device after a layer has been formed often requires depositing a contact material to the surface, which may bring impurities to the deposited material and would need to be removed prior to further processing. Such impurities may interfere with proper formation of future layers and thus cause irreversible changes to the device. Further, the device may have to be taken out of the sterile environment in order to attach the contacts. Doing so may disrupt the processing flow of the device's manufacture. The physical contact may also disturb the layer contacted resulting in layer damage.

Consequently, what is needed is a nondestructive metrology system that is integral to the manufacturing line and a related method to probe photovoltaic device characteristics and/or properties during its construction with a simple low-cost method.

### BRIEF DESCRIPTION OF DRAWINGS

FIG. 1A is a diagram illustrating a metrology system according to a first embodiment.

FIG. 1B is a diagram illustrating a metrology system according to a second embodiment.

FIG. 1C is a diagram illustrating a metrology system according to a third embodiment.

FIG. 2 is a cross section of an exemplary photovoltaic device.

FIG. 2A is a cross section of an exemplary photovoltaic device according to a disclosed embodiment.

FIG. 3A is a diagram illustrating a metrology system according to a fourth embodiment.

FIG. 3B is a diagram illustrating a metrology system according to a fifth embodiment.

FIG. 4 is a diagram illustrating a metrology system according to a sixth embodiment.

FIG. 4A is a diagram illustrating a metrology system according to a seventh embodiment.

FIG. 5 is a diagram illustrating a metrology system according to a eighth embodiment.

FIG. 5A is a diagram illustrating a metrology system according to a ninth embodiment.

FIG. 6 is a diagram illustrating a metrology system according to an tenth embodiment.

FIG. 7 is a diagram illustrating a metrology system control mechanism.

### DETAILED DESCRIPTION

In the following detailed description, reference is made to the accompanying drawings, which form a part hereof and illustrate specific embodiments of the invention. These embodiments are described in sufficient detail to enable those skilled in the art to make and use them. It is to be understood that structural, logical, or procedural changes may be made to the specific embodiments disclosed without departing from the spirit and scope of the invention. It should be understood that like reference numbers represent like elements throughout the drawings.

In order to test that a PV device's layers have been formed correctly, the method and system embodiments disclosed herein employ electrolytic cells to make electrical contact with the PV device for the purpose of measuring electrical characteristics, such as current/voltage (I/V) characteristics, during the manufacturing process. The I/V characteristics of a PV device refer to the current output by the PV device when the voltage output of the PV device is controlled, or the voltage output by the PV device when the current output of the PV device is controlled.

An electrolytic cell needs, at a minimum, three component parts: an electrolyte and two electrodes. The electrolyte is usually a solution of a solvent or solvents, such as water, in which a solute, such as a salt, is dissolved. When a voltage is generated at the electrodes, the electrolyte solution provides ions that flow to and from the electrodes, where charge-transferring reactions can take place. The solution makes a non-destructive contact with a layer on the PV device, which acts as one electrode, while at least one other electrode contacts the electrolyte solution without contacting the layer. According to one embodiment, the electrolytic cells are formed with an electrolyte solution in contact with a controlled surface contact area on a PV device. The controlled surface contact area may be a test site on the PV device (i.e. a non-active PV cell or cells) in order to reduce further risk of damage to functional PV cells.

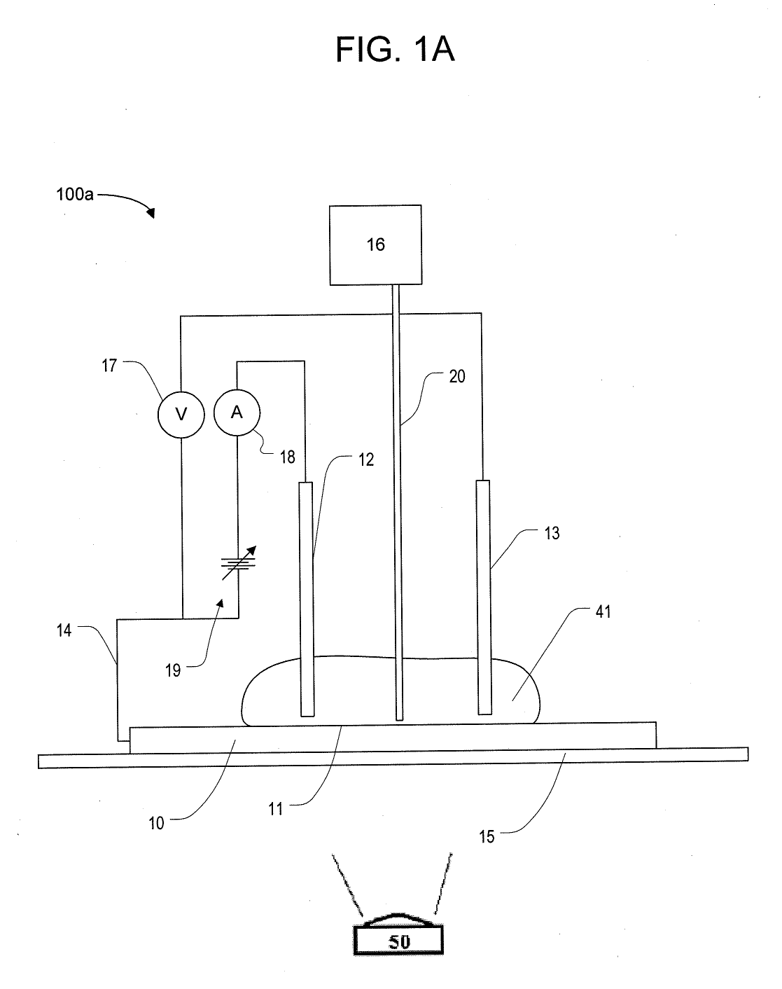

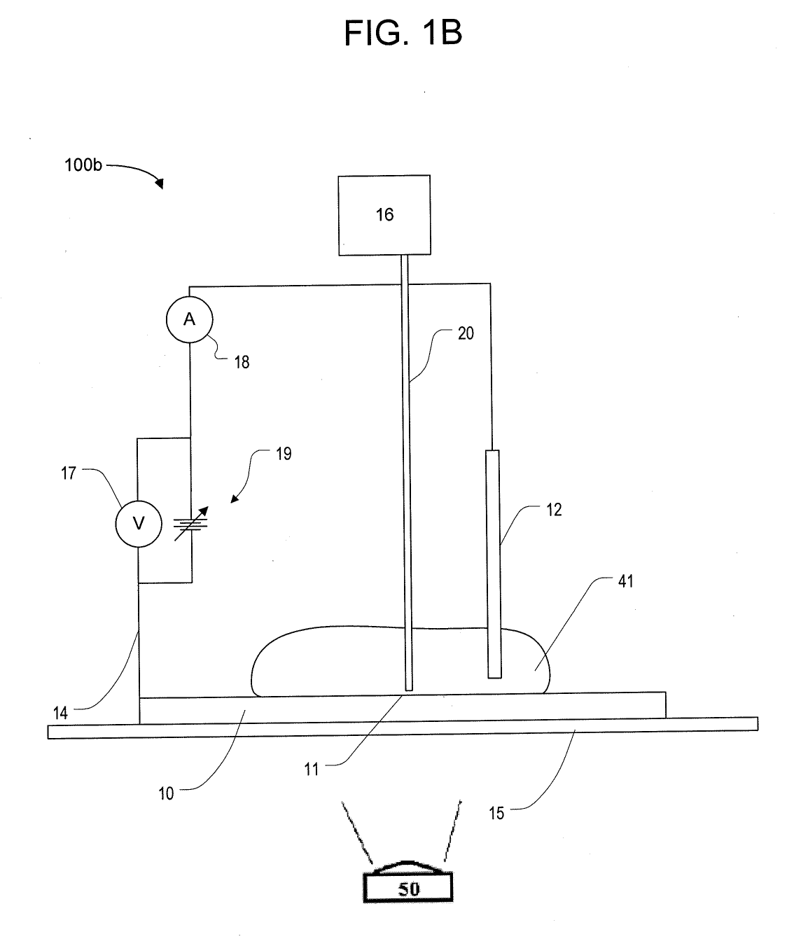

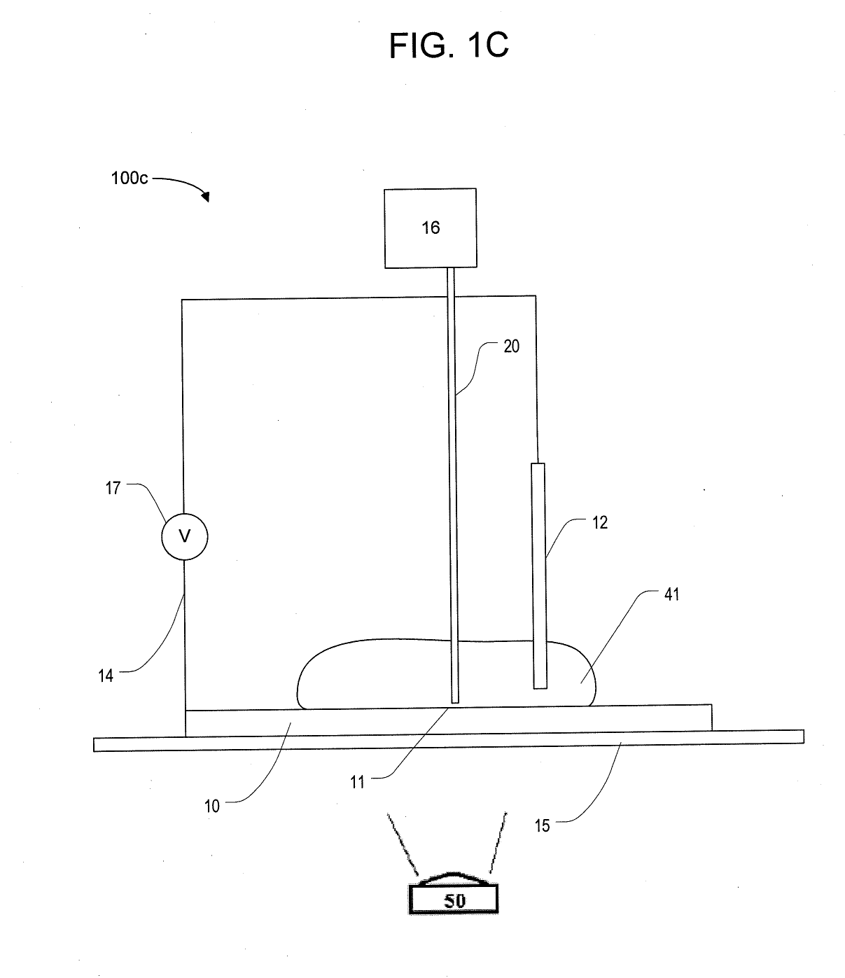

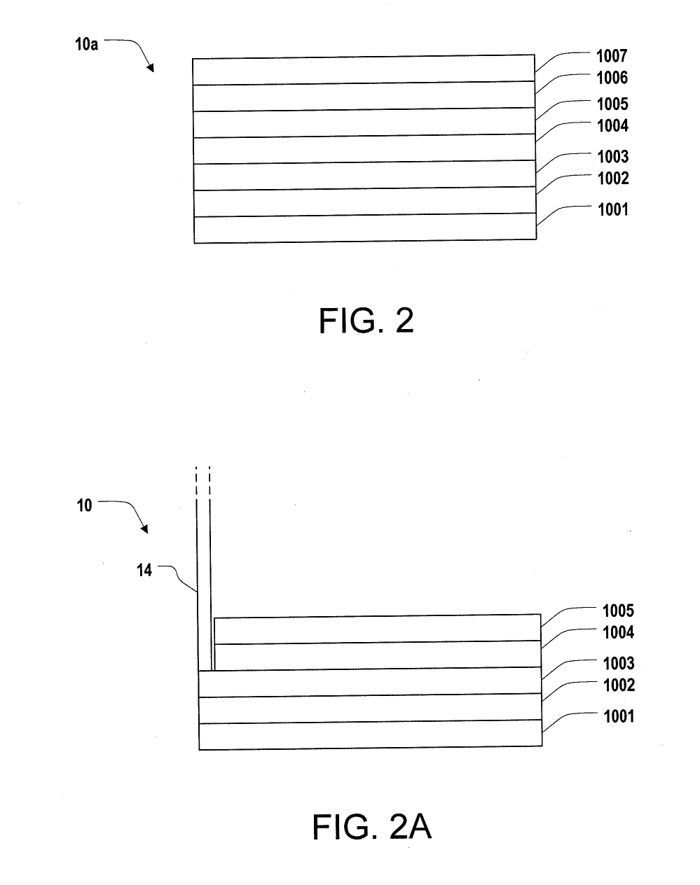

Referring to FIG. 1A, a basic three-electrode metrology system 100a for testing a partially manufactured PV device 10 is depicted. In order to avoid interrupting the manufacturing process and to create an inline system, the PV device 10 is transported to the metrology system 100a using a conveyor system 15 or similar transportation device, where an electrolyte solution 41 is applied to the portion of the PV device 10 for which testing is desired. In one embodiment, the electrolyte solution 41 is applied immediately after coating the module with a semiconductor layer (e.g., semiconductor layer 1005 (FIG. 2)) comprising a window and absorber layer and before annealing. In another embodiment, the electrolyte solution 41 is applied to the PV device 10 after the semiconductor layer (e.g., layer 1005) is annealed. In a third embodiment, the electrolyte solution 41 is applied to the PV device 10 after other layer treatments, such as chemical treatment, are completed, but before subsequent layers (e.g., back contact layer 1006 and back cover 1007) are deposited.

The three-electrode metrology system 100a may be composed of a measurement circuit, which includes a PV device contact 14, a voltmeter 17, an ammeter 18, and electrical source 19, and an electrolytic cell, which contains an electrolyte solution 41, first electrode 12, and third electrode 13. The PV device surface 11 contacted by electrolyte solution 41 acts as the second electrode in this three-electrode electrolytic cell. The electrical source 19 acts as a variable or constant current or voltage source and provides a continuous or stepwise method of increasing and decreasing the applied electrical voltage or current. The electrical current flows through the first electrode 12, into the electrolyte solution 41, and completes the circuit through the contact surface 11, the PV device 10, and the PV device contact 14. The ammeter 18 measures the current flowing through the PV device 10. The third electrode 13 can be placed in proximity to the contact surface 11, enabling more accurate measurements of the potential experienced at the contact surface 11. Measurement of the current levels by the ammeter 18 and the voltmeter 17 in response to the increased and/or decreased output of the electrical source permits measurement of the IN curve of the PV device 10.

As further illustrated in FIG. 1A, the metrology systems 100a may also include an adjustable light source 50 for illuminating PV device 10 during measurements to activate the PV device 10 and control the light received by the PV device 10. The current and voltage output of the PV device 10 can be adjusted and controlled by varying the intensity of light source 50 during measurements of PV device 10. When a given intensity of light is applied to the photosensitive surface of the PV device, i.e. when the light is applied to the PV device 10 through the substrate 1001 shown in FIG. 2, the PV device 10 should operate within given current and/or voltage output parameters. By increasing and decreasing the light intensity, the metrology system 100a can change the current and voltage output in order to test the I/V characteristics of the PV device 10 at different light intensities.

Once the electrolyte solution 41 is applied to the PV device 10 and the electrodes are inserted into the solution 41 and remain spaced away from the contact surface 11, the I/V characteristics of the PV device 10 is measured by, in one embodiment, sweeping the current applied by first electrode 12 to measure the voltage characteristics of the PV device 10. The metrology system 100a can sweep the current from a lower limit, approximately 0 mA/cm² of PV device surface tested, to an upper limit as desired. The upper limit could be any selected current per unit of surface area of the device. For example, the upper limit may be 1 mA/cm², 10 mA/cm², 25 mA/cm², or 50 mA/cm². If the sample is illuminated by light source 50, the lower current limit may be less than 0 mA/cm² (i.e. a negative current), but not lower than the short circuit current of the PV device 10. This allows the system to test the voltage characteristics of the contact surface 11 at a range of currents. In another embodiment, to measure the current characteristics of the PV device, the metrology system sweeps the voltage applied from a lower limit to an upper limit and monitors the current characteristics of the PV device surface at a range of voltages. In one form of this embodiment, the voltage applied by the first electrode is swept from approximately −1 volt to 1 volt. In another embodiment, the voltage is swept from 0 volts to 1 volt. The voltage range can be adjusted according to the material or device being tested and the state of the manufacturing process where the test is performed.

In another embodiment, shown in FIG. 1B, a two-electrode metrology system 100b can be employed to test the UV characteristics of a PV device 10. This system 100b operates in a similar fashion to that described above, with the omission of the third electrode 13. Similarly to the embodiment shown in FIG. 1A, the PV device surface 11 contacted by electrolyte solution 41 acts as the second electrode in this two-electrode electrolytic cell. In this embodiment, the voltage within the electrolytic cell is measured against or with respect to the first electrode 12 whose potential may vary with the level of current passed through the electrolytic solution 41 and conditions of the electrolytic solution 41 (e.g., pH, temperature, etc.). Omission of the third electrode 13 simplifies the system, but increases the risk of reporting less accurate voltage variations because of the variation due to current and solution conditions. As a result, the two-electrode system may provide a less accurate, but acceptable, measurement of IN characteristics of a PV device 10.

In another embodiment, shown in FIG. 1C, the two-electrode metrology system 100c can be operated without the electrical source 19. Instead, the PV device 10 acts as the electrical source, and the metrology system 100c operates by measuring the voltage of the PV device 10 while the PV device 10 is illuminated. In one embodiment, the illumination level is held constant, and a single voltage output point is determined. In another embodiment, the illumination level is increased or decreased continuously or stepwise and the change of the voltage is measured as a function of the illumination intensity of the light source 50.

The metrology system 100a,b,c can further include a solution control module 16, as shown in FIGS. 1A, 1B, and 1C, for releasing and controlling the amount of the electrolyte solution 41 deposited on the PV device 10 surface to form the solution contact, as well as the location on the PV device 10 on which the electrolyte solution 41 is placed. In the embodiment shown in FIGS. 1A, 1B, and 1C, a tube 20 transports the electrolyte solution 41 from the solution control module 16 to the PV device 10. The end of the tube 20 is spaced from and does not touch the contact surface 11. The solution control module 16 can also withdraw the electrolyte solution 41 from the contact surface 11 after measurement via the tube 20. The solution control module 16 may be integral with a structure supporting the electrodes 12, 13 so that the electrodes 12, 13 are always located within a deposited electrolyte solution 41.

As shown in FIG. 2A, in one embodiment, the PV device contact 14 is configured to contact the TCO layer 1003 of the PV device 10. This may be done by laser ablation, mechanical removal, or chemical etching of layers (e.g., 1004, 1005) of the PV device 10 to expose the TCO layer 1003, or the PV device contact 14 may be inserted through the layers (e.g. 1004, 1005) mechanically, such as a needle probe. This contact is preferably formed at a location on the substrate that does not contain an active PV device in the finished product, e.g., along the PV device's perimeter or adjacent to a non-active PV cell.

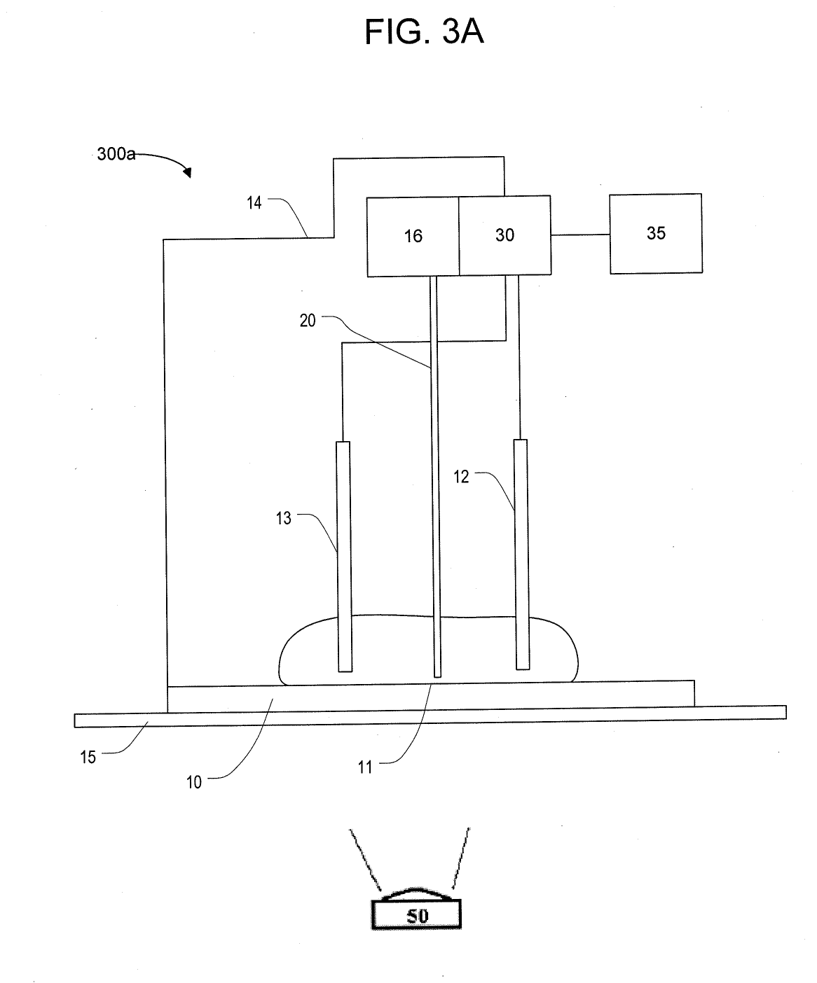

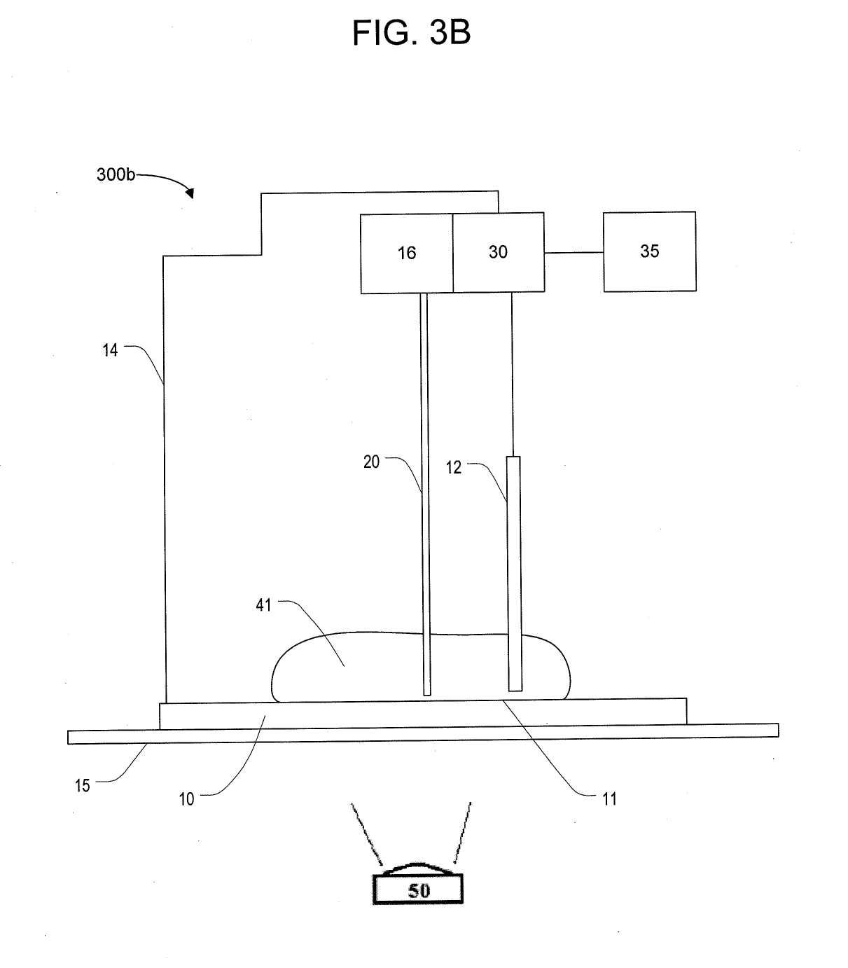

In another embodiment, shown in FIG. 3A, the measurement circuit including the voltmeter 17, ammeter 18, and electrical source 19 of the metrology system 100a of FIG. 1A is incorporated into a processing module 30 that generally includes a power supply and a device analyzer or potentiostat for various electrochemical tests and/or electrical measurements. Device contact 14 to the TCO layer 1003 is also provided. The processing module 30 of the metrology system 300a is utilized to measure the I/V characteristics of the contact surface 11 of the PV device 10. The processing module 30 can also control the electrodes 12, 13 and run electroanalytical tests on the PV device 10. Based on taken measurements, the processing module 30 can estimate and predict the performance of the PV device 10 when installed and in use by utilizing mathematical modeling. Similarly, a processing module 30 may be utilized in the two-electrode cell metrology system 300b as shown in FIG. 3B. The processing module 30 and the solution control module 16 may be formed as an integral unit to control the solution and electrodes from a central location.

As is shown in FIGS. 3A and 3B, the metrology system 300a, 300b can further include a feed-back control loop integrated with the manufacturing process 35 where the measuring circuit or processing module 30 compares the I/V characteristics to a given parameter. If the I/V characteristics are beyond the given parameter or irregular, the metrology system 300a, 300b then provides information to the manufacturing process 35 for adjusting the semiconductor film deposition, anneal process, or other of the manufacturing processes to correct for any measured irregularities. In some embodiments, metrology system 300a, 300b can adjust the measured location of the semiconductor material and test multiple locations on the PV device 10 for spatially mapping a semiconductor device to determine the uniformity of the I/V characteristics for the PV device 10.

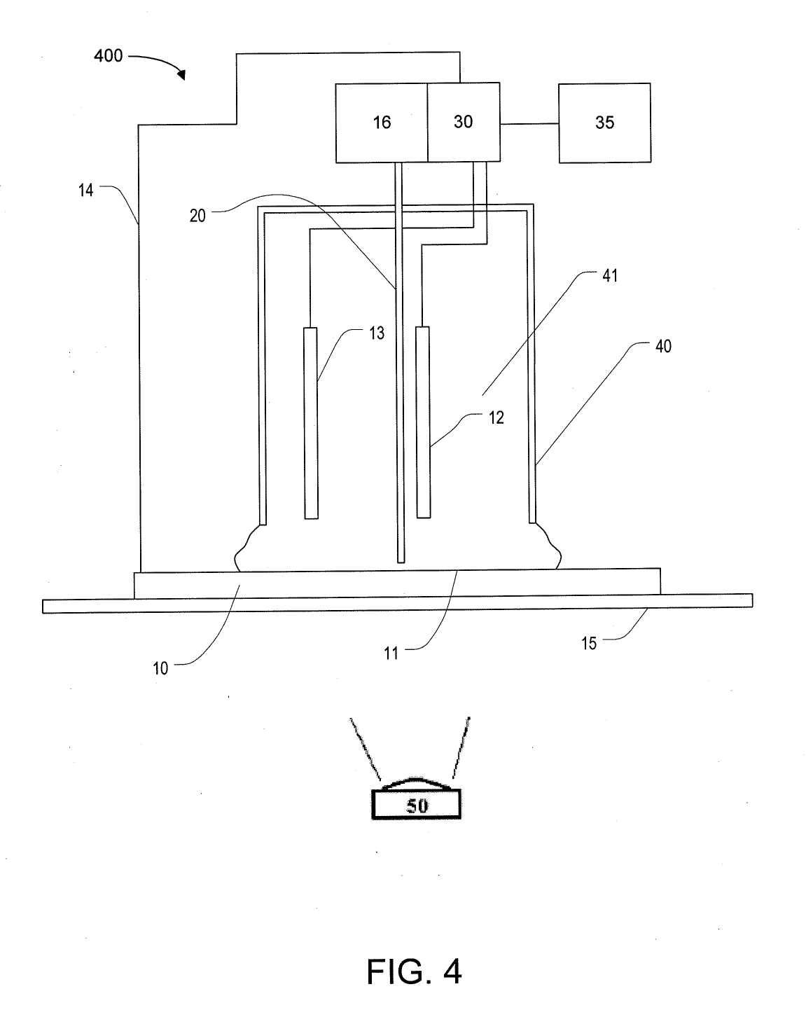

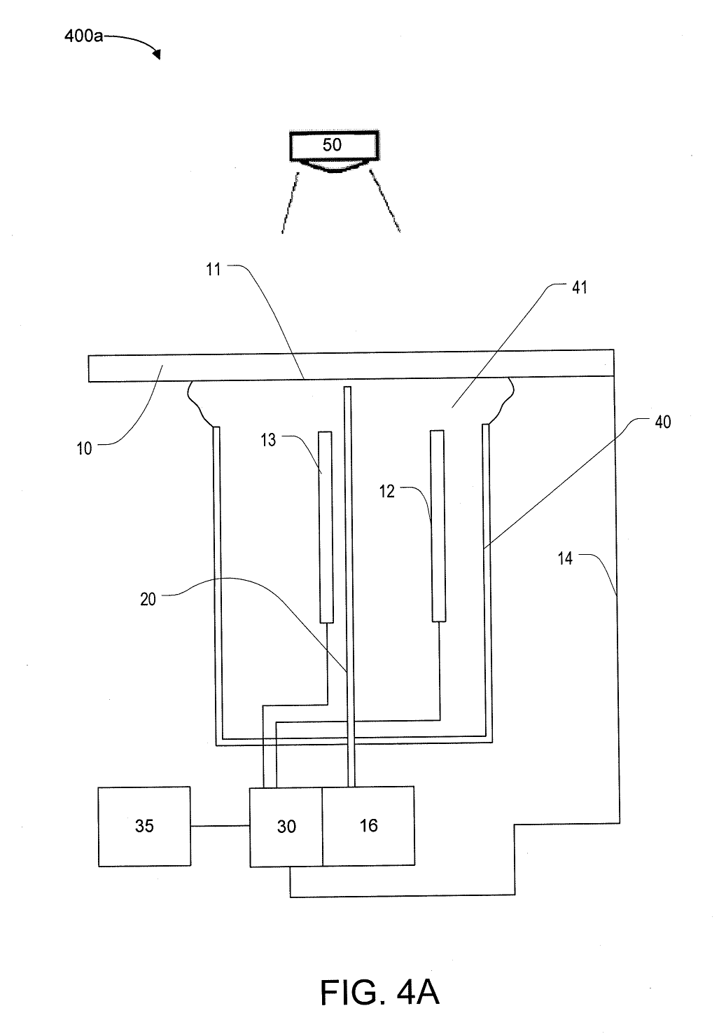

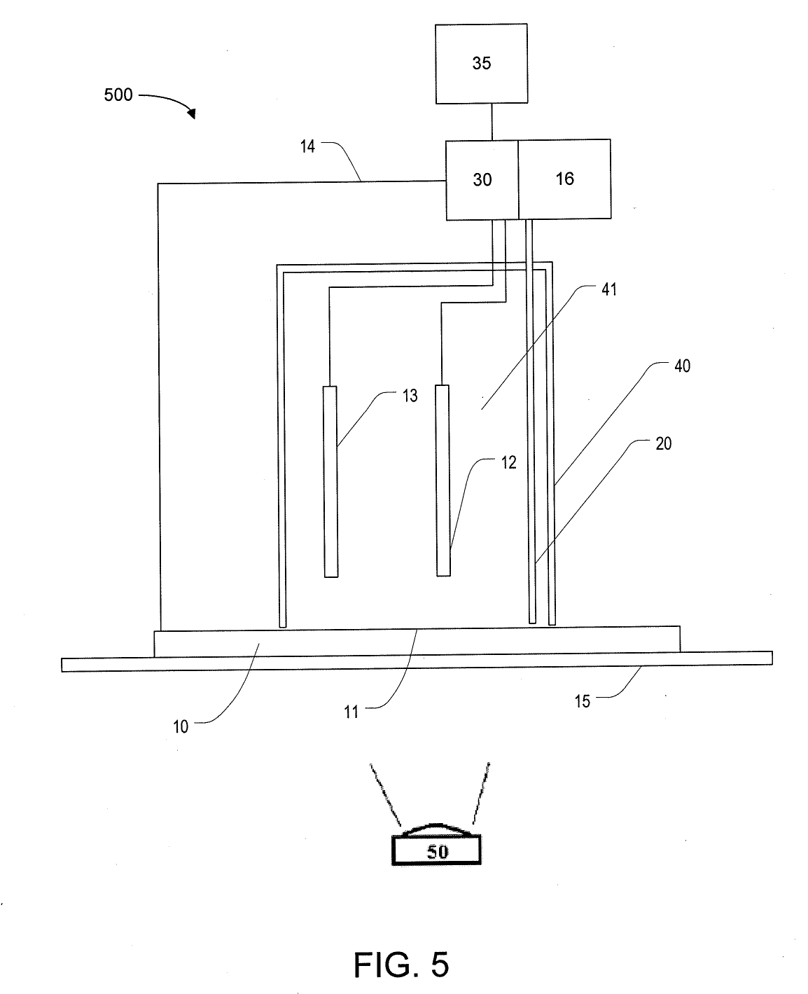

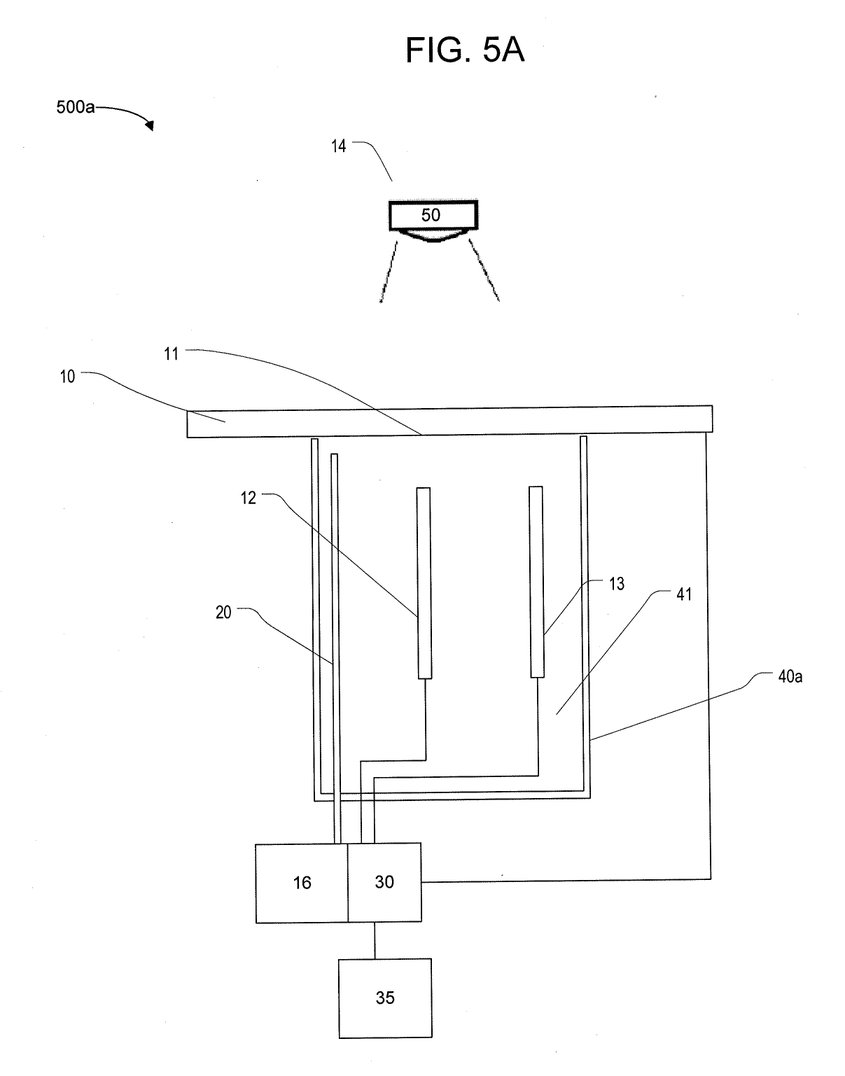

As shown in FIGS. 4 and 5, the metrology system 400, 500 may also include a chamber 40, formed of glass or another material. The chamber 40 contains the electrolyte solution 41 and electrodes 12, 13. In order to test the PV device 10, the chamber 40 is placed adjacent to the PV device 10. The control module 16 then releases the electrolyte solution 41 within the chamber 40 to contact the PV device 10 for testing. By utilizing the chamber 40, the metrology system 400, 500 can more accurately control the area of the contact surface 11 that is tested. The chamber 40 also allows for an increased surface area contact between the electrodes 12, 13 and the electrolyte solution 41 when compared to the metrology system 100a, 100b, 100c, 300a, 300b of FIGS. 1A, 1B, 3A, 3B.

In another embodiment, shown in FIGS. 4A and 5A, the metrology system (e.g., 400a and 500a) may be operated from below the PV device 10 in an upward fashion with the contact surface 11 of the PV device 10 facing downwards.

As shown in FIG. 4, if utilizing an electrolyte solution 41 of a suitable higher viscosity, the chamber 40 can be spaced from the PV device 10 by a larger distance when the metrology system 400 is in operation. In another embodiment, using a lower viscosity solution 41 and as shown in FIG. 5, the chamber 40 may be configured to be placed closer to the PV device 10 to create a better contact between the electrolyte solution 41 and the contact surface 11, as well as prevent or reduce flow of the electrolyte solution 41 across the PV device 10 and into contact with sections of the PV device 10 that are not to be tested. In addition, the contact surface 11 area of the PV device 10 measured can be controlled by adjusting the size of the chamber 40 or utilizing chambers of differing size and configuration for various measurements.

To make a reliable solution contact to the PV device 10, the electrolyte solution 41 should be released in a well-controlled manner to reduce entrapped air and control other issues that may cause poor contact with the PV device 10 using a solution control system 16. Once the testing is finished, the solution 41 can be drawn away from the contact surface 11 and into the chamber 40 for next use or discarded. After the electrolyte solution 41 has been drawn into the chamber 40 or discarded, the PV device 10 may be rinsed to remove any remaining electrolyte solution 41 or contaminants.

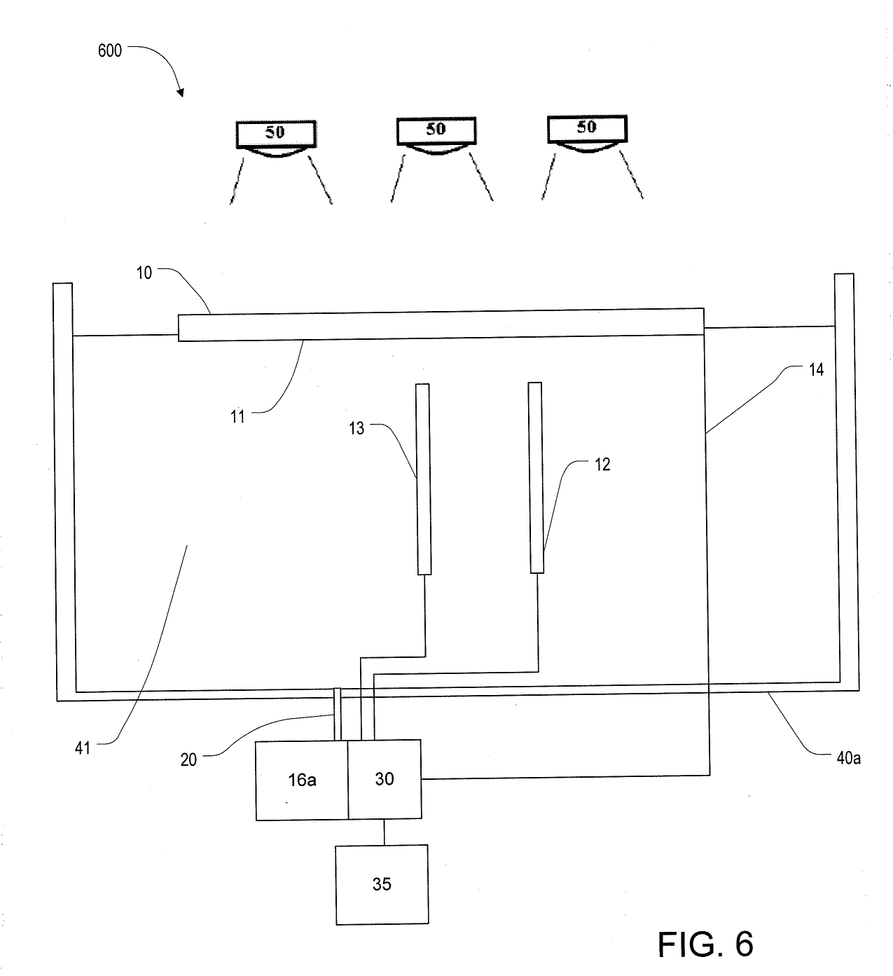

In the embodiments shown in FIGS. 4 and 5, only a portion of the PV device 10 is tested. Thus, individual PV cells of the PV device 10 or groups of PV cells less than the entire PV device 10 may be tested. In another embodiment, illustrated in FIG. 6, the chamber 40a for a metrology system 600 may be formed large enough to accommodate an entire PV device 10 in order to analyze the ITV characteristics of the PV device 10 as a whole. Unlike the operation of the metrology systems 100a, 100b, 100c, 300a, 300b, 400, 400a, 500, the PV device 10 in the metrology system 600 of FIG. 6 is placed with the contact surface 11 facing down into an electrolyte solution 41 bath. The substrate layer (i.e. substrate 1001 of FIG. 2) faces up towards a light source 50. The electrodes 12, 13, PV device contact 14, processing module 30, and light sources 50 operate as described above with respect to FIGS. 1A, 1B, 3A, 3B, 4, and 5. The electrolyte solution 41 can be pumped into and removed from the chamber 40a using a solution control module 16a, which operates similar to the solution control module 16 described above.

In the embodiments described above, measuring the I/V characteristics of a portion of a PV device 10 or a PV device 10 as a whole may generate a non-uniform electric field. Different voltage generation rates may occur at different sections of the PV device 10 due to, for example, non-uniform illumination of the PV device 10 or defective cells within the PV device 10. To compensate for differing voltage generation rates by the PV device 10, the size and position of the first electrode 12 relative to the contact surface 11 can be adjusted to generate a uniform electric field between the contact surface 11 and the first electrode 12 and thus provide a uniform current distribution on both the contact surface 11 and the first electrode 12. For example, the first electrode 12 surface area can be equal or slightly larger than contact surface 11 of the PV device 10 to be tested. In addition, the orientation of the electrodes 12, 13 may be adjusted to increase or decrease the surface area of the electrodes 12, 13 in contact with the electrolyte solution 41 as desired. Furthermore, the volume of electrolyte solution 41 applied to the contact surface 11 may be modified as desired.

After the desired device property measurements are performed using the metrology system according to the disclosed embodiments illustrated as 100a, 100b, 100c, 300a, 300b, 400, 400a, 500, 500a, 600 the PV device 10 is ready for other manufacturing process steps without any irreversible or undesirable changes caused by the metrology system that may impede or adversely impact the downstream module processing.

The electrolyte solution 41 can include chemicals to provide a desired conductivity range, reduce solution resistance in the electrolytic cell, and provide redox reactions. The conductivity and redox characteristics are a function of the materials used to form the electrodes as well as the material construction of the PV device 10. Depending on the configuration of PV device 10, electrodes 12, 13, and the electrolyte solution 41 used, the first and third electrodes 12, 13 may each function as either the anode or the cathode of the electrolytic cell. To provide a desired conductivity, any easily dissociated chemicals can be included, such as a salt (e.g., potassium, sodium, lithium) in any anionic form (e.g., chloride, sulfate, phosphate, nitrate, carbonate) in aqueous solutions and LiClO4 or tetraalkylammonium salts in organic media (e.g., MeCN, DMF, THF, alcohols). For redox reactions, any suitable electroactive chemical (redox probe) can be used. Ferricyanide ([Fe(CN)₆]³⁻), ferrocyanide ([Fe(CN)₆]⁴⁻), and some metal cations or complexes can work as redox probes in aqueous media. Ferrocene, benzoquinone, Tris(bipyridine)ruthenium(II) chloride ([Ru(bipy)₃]Cl₂), tetracyanoquinodimethane (TCNQ), tetrathiafulvalene (TTF), porphyrins, phthalocyanines and their derivatives can function as redox probe in organic media.

A lag between a change in an applied electrical signal and the I/V characteristic response, is typical when measuring the I/V characteristics in the electrolytic cells of the embodiments described above because of the electric double layer naturally formed between electrode and solution at the interface. The amount of lag can be managed by using different solvents; by using different solutes; by changing the measurement techniques, such as stepping the voltage applied rather than continuously sweeping the voltage or current applied (chronoamperometry); or by changing the measurement conditions, such as varying the scan rates.

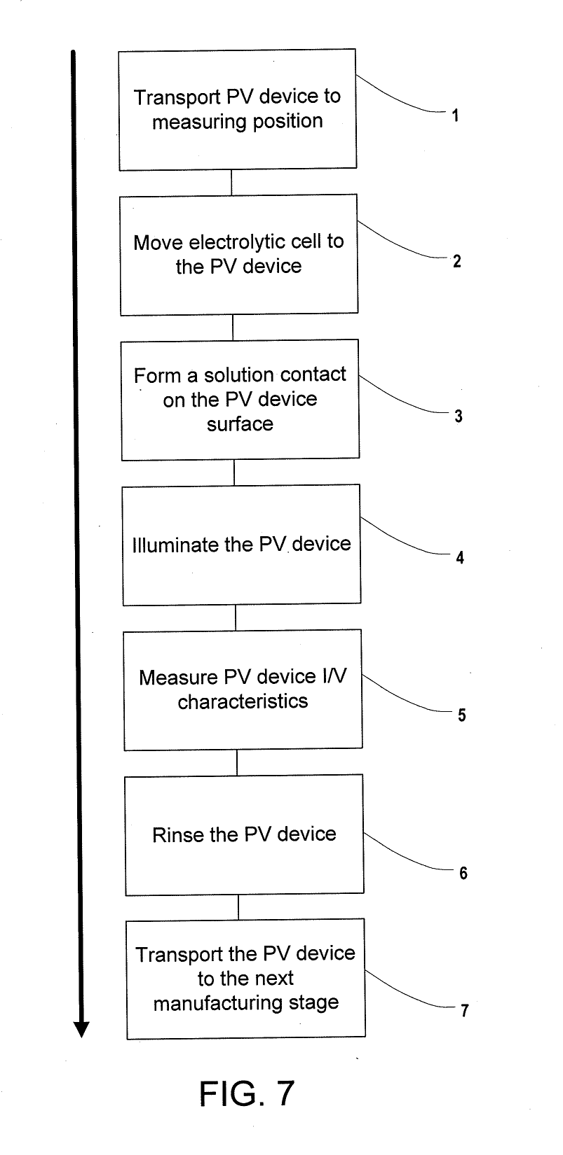

FIG. 7 depicts a method of testing a PV device using any of the metrology systems 100a, 100b, 100c, 300a, 300b, 400, 400a, 500, 500a, 600 described above. The method includes: step (1) transporting the PV device to a measuring position; step (2) positioning a metrology system of one of the embodiments described above adjacent to the contact area of the device to be tested; step (3) forming a contact between the electrolyte solution and the PV device surface area to be tested; step (4) illuminating the PV device to generate a potential or current; step (5) measuring the I/V characteristics of the PV device as described above; step (6) rinsing the PV device to remove any electrolyte solution or contaminants; and step (7) ending the measurement and transporting the PV device to a subsequent manufacturing station. Some tests may be performed without illuminating the PV device, in which case step (4) is eliminated.

While several embodiments have been described in detail, it should be readily understood that the invention is not limited to the disclosed embodiments. Rather the embodiments can be modified to incorporate any number of variations, alterations, substitutions or equivalent arrangements not heretofore described. Although certain features have been described with some embodiments of the metrology system, such features can be employed in other embodiments of the metrology system as well. Accordingly, the invention is not limited by the foregoing description, but is only limited by the scope of the appended claims.

What is claimed is:

1. A metrology system for analyzing a semiconductor device comprising:
an electrolytic cell comprising:
a source of an electrolyte solution configured to provide the electrolyte solution in contact with at least a portion of a semiconductor material of the semiconductor device; and
a first electrode in contact with a provided electrolyte solution to enable measurement of electrical characteristics of the semiconductor device, wherein the portion of the semiconductor material of the semiconductor device acts as a second electrode when contacted by the electrolyte solution; and
a measurement circuit for taking electrical measurements using the electrolyte solution and the first electrode.

2. The metrology system of claim 1, wherein the first electrode is configured to apply at least one of a current and a voltage to the electrolyte solution.

3. The metrology system of claim 1, further comprising a third electrode located within a provided solution configured to establish a known reference potential in the electrolyte solution.

4. The metrology system of claim 2, wherein the measuring circuit comprises a source of at least one of voltage and current coupled to the first electrode.

5. The metrology system of claim 1, wherein the measurement circuit further comprises a device contact configured to contact a portion of a transparent conductive oxide layer of the semiconductor device.

6. The metrology system of claim 1, wherein the measuring circuit comprises a processing module.

7. The metrology system of claim 1, wherein at least one of the voltage characteristics and the current characteristics of the semiconductor device are measured during the analysis.

8. The metrology system of claim 1, wherein the electrolytic cell further comprises a chamber for supplying and withdrawing the electrolyte solution.

9. The metrology system of claim 8, wherein the chamber does not contact the semiconductor material of the semiconductor device.

10. The metrology system of claim 8, wherein the chamber is configured such that the solution is provided in contact with an entirety of a surface of the semiconductor material of the semiconductor device.

11. The metrology system of claim 1, wherein the source of electrolyte solution comprises a solution control module for controllably releasing the electrolyte solution.

12. The metrology system of claim 11, wherein the solution control module is configured to withdraw the electrolyte solution from the semiconductor material of the semiconductor device.

13. The metrology system of claim 1, further comprising at least one light source for illuminating the semiconductor device during electrical measurement.

14. The metrology system of claim 13, wherein intensity of the light source is adjustable.

15. The metrology system of claim 1, wherein the electrolyte solution comprises at least one salt.

16. The metrology system of claim 1, wherein the electrolyte solution comprises at least one material selected from the group consisting of chlorides, sulfates, phosphates, nitrates, and carbonates.

17. The metrology system of claim 15, wherein the electrolyte solution comprises a salt in an aqueous media.

18. The metrology system of claim 15, wherein the electrolyte solution comprises a salt in an organic media.

19. The metrology system of claim 1, wherein the first electrode comprises at least one of ferricyanide, ferrocyanide, ferrocene, benzoquinone, Tris(bipyridine)ruthenium(II) chloride, tetracyanoquinodimethane, tetrathiafulvalene, porphyrins, or phthalocyanines.

20. The metrology system of claim 1, wherein the semiconductor device is a photovoltaic device and the semiconductor material is a semiconductor layer of the photovoltaic device.

21. A method of analyzing a semiconductor device during a semiconductor device manufacturing process comprising:
applying an electrolyte solution to at least a portion of a semiconductor material of the semiconductor device;
applying a first electrode to the electrolyte solution, wherein the first electrode is configured to enable measurement of electrical characteristics of the semiconductor device and wherein the portion of the semiconductor material of the semiconductor device acts as a second electrode when being analyzed;
applying at least one of a voltage and current to the electrolyte solution; and
analyzing at least one electrical characteristic of the semiconductor device based on the one of a voltage and current applied to the electrolyte solution.

22. The method of claim 21, further comprising applying a third electrode to the electrolyte solution, wherein the one of a voltage and current is applied to the electrolyte solution at the third electrode.

23. The method of claim 21, further comprising applying at least one of a current and a voltage to the electrolyte solution at the first electrode.

24. The method of claim 21, further comprising applying at least one of a current and a voltage to the electrolyte solution at the portion of the semiconductor material of the semiconductor device.

25. The method of claim 23, further comprising:
sweeping a current output of the first electrode from approximately 0 mA/cm² to an upper current limit; and
measuring voltage characteristics of the semiconductor device.

26. The method of claim 23, further comprising:
sweeping a current output of the first electrode from a negative lower current limit, which is equal to or larger than the short-circuit current of the semiconductor device to an upper current limit; and
measuring voltage characteristics of the semiconductor device.

27. The method of claim 23, further comprising:
sweeping a voltage output of the first electrode from a lower voltage limit to an upper voltage limit; and
measuring current characteristics of the semiconductor device.

28. The method of claim 21, wherein applying the electrolyte solution comprises releasing the electrolyte solution from a solution control module against the semiconductor material of the semiconductor device.

29. The method of claim 21, further comprising placing a chamber containing the electrolyte solution adjacent to the semiconductor material of the semiconductor device.

30. The method of claim 29, wherein the chamber does not contact the semiconductor device.

31. The method of claim 21, further comprising inserting the semiconductor device into a bath comprising the electrolyte solution.

32. The method of claim 28, further comprising withdrawing the electrolyte solution from the semiconductor material of the semiconductor device.

33. The method of claim 21, further comprising illuminating the semiconductor device during the analysis with a light source.

34. The method of claim 33, further comprising varying an intensity of the light source during the analysis.

35. The method of claim 21, further comprising rinsing the semiconductor material of the semiconductor device.

36. The method of claim 21, further comprising:
comparing the electrical characteristic to a parameter to determine irregularities in the electrical characteristic;
communicating the comparison to the manufacturing process; and
adjusting the semiconductor device manufacturing process to compensate if irregularities are determined.

37. The method of claim 21, further comprising:
applying the electrolyte solution to at least a second portion of the semiconductor material of the semiconductor device;
applying the first electrode to the electrolyte solution, wherein the first electrode is configured to establish a reference potential in the electrolyte solution; and
analyzing at least one electrical characteristic of the semiconductor device at the second portion of the semiconductor material based on the reference potential generated in the electrolyte solution.
